(19) United States
(12) Patent Application Publication
(10) Pub. No.: US 2008/0128545 A1
(43) Pub. Date: Jun. 5, 2008

(54) Carrying Device, Recording Device, and Carrying Method

(75) Inventor: Masaru Midorikawa, Chiba (JP)

Correspondence Address: Bruce L. Adams;Adams & Wilks, 17 Battery Place, Suite 1231, New York, NY, 10004, US

(73) Assignee: SEIKO I INFOTECH INC., CHIBA-SHI, CHIBA (JP)

(21) Appl. No.: 11/883,411

(22) PCT Filed: Feb. 8, 2006
(86) PCT No.: PCT/JP06/02115

§ 371 Date: Sep. 25, 2007

(30) Foreign Application Priority Data
Feb. 24, 2005 (JP) 2005-049552

(51) Int. Cl. B41J 11/02; B65H 16/06

(52) U.S. Cl. 242/596; 270/1.01

(57) ABSTRACT

A carrying device includes: a supply portion (16) for supplying a recording sheet (3) from a supply roll (11) wound with the recording sheet (3); a platen (18), which is opposed to a recording head (7) for performing recording on the recording sheet (3) supplied from the supply portion (16), for supporting the recording sheet (3); a take-up portion (20) in which the recording sheet (3) on which recording has been performed by the recording head (7) is taken up by a take-up roll (12); and a suction fan (52) for sucking the recording sheet (3) supported on the platen (18). The platen (18) is provided with, in a position corresponding to an area in which recording is performed by the recording head (7), a plurality of recessed portions (48), which are formed from an upstream side to a downstream side of the platen (18) in a carrying direction of the recording sheet (3) and are surrounded by projected walls (49), aligned in a width direction of the recording sheet (3). In bottom surfaces in the recessed portions (48), there are provided a plurality of suction holes (51) for sucking the recording sheet (3) by the suction fan (52). As a result, quality of recording by the recording head is increased by suppressing occurrence of wrinkles on a recording material which is carried.

### TECHNICAL FIELD

The present invention relates to a carrying device for carrying a recording material when, for example, an image or the like is recorded on the recording material such as a recording sheet having a relatively large width, a recording device, and a carrying method.

### BACKGROUND ART

Conventionally, there are known inkjet printers in which ink droplets are ejected onto a recording material such as a recording sheet to record characters, images, or the like. Among the ink jet printers described above, there are provided relatively large printers for performing recording on a recording material made of paper or vinylchloride, having a relatively large width; for example, a width of the recording material perpendicular to a carrying direction thereof is about 2 m to 2.5 m.

The printer of this type includes a recording unit for performing recording on the recording material and a carrying unit for carrying the recording material on which recording is performed by the recording unit. The recording unit includes a recording head for ejecting ink droplets onto the recording material and a head moving mechanism for allowing the recording head to scan in the width direction of the recording material perpendicular to the carrying direction thereof. The carrying unit includes a supply portion for supplying the recording material from a supply roll wound with the recording material, a platen for supporting the recording material on which recording is performed by the recording head, and a take-up portion for taking up the recording material on which recording has been performed by the recording head around a take-up roll.

In the conventional printer structured as described above, the recording material supplied from the supply roll of the supply portion is supported on the platen, and the recording is performed by the recording head. The recording material on which the recording has been performed is taken up by the take-up roll of the take-up portion.

With the conventional printer of this type, in a case of using a recording material such as a material like so-called tarpaulin or fabric having uneven distribution of crude density obtained by laminating particularly a base body with a synthetic resin, the base body having fibers woven therein, wrinkles tend to occur, which are rippled in a thickness direction with respect to the carrying direction of the recording material to be carried. Also, when the recording is performed on the wrinkled recording material, positions where the ink droplets ejected from the recording head reach are shifted. This leads to deterioration in quality of images or the like recorded on the recording material. Further, there is a problem in that the recording material, which is carried while being wrinkled, is partially floated from the platen, and a portion floated therefrom collides with the recording head. As a result, it is likely to damage the recording head and to soil the recording material with ink droplets.

As a countermeasure for suppressing occurrence of wrinkles on the recording material carried on the platen, there is disclosed a structure in which a projected/recessed guide portion is provided onto a downstream side of the platen, and the recording material is sucked to and supported on a recording area and a projected portion of the platen (see, for example, JP-A-2000-6387 (FIG. 2)).

However, in the conventional printer disclosed in Patent Document 1, the projected/recessed guide portion is provided on the downstream side of the platen, so it is required to ensure, in the carrying direction of the recording material, a space for arranging the recording area and the projected/recessed guide portion of the platen. Therefore, there is a problem in that a size of the printer is increased toward the carrying direction. Further, with the conventional printer, it is difficult to straighten and flatten the wrinkles occurred by being bent due to an own weight of the recording material.

In the printer described above, as a factor of causing the wrinkles on the carried recording material, there are conceived the following problems.

The supply roll supported in the supply portion has a structure in which the recording material is wound around a support tube formed of paper (herein after, referred to as paper tube), and the supply roll is supported by inserting, into the paper tube, a roll shaft with an axis thereof being horizontal. Therefore, there is a problem in that in the supply roll, the recording material is curved inwardly at a central part in a width direction thereof due to the own weight of the recording material which has been wound, and is bent with respect to the width direction. There is a disadvantage in that wrinkles easily occur on the recording material drawn out from the supply roll thus bent.

Further, when the recording material made of vinyl chloride and formed into a sheet shape is used, apart of the recording material wound around the supply roll easily adheres to another part thereof. When there exist a part where adhesion occurs and a part where the adhesion does not occur in the width direction of the recording material, presence and absence of the adhesion cause partial irregularity in tensile force. As a result, there is a problem in that wrinkles easily occur on the recording material to be supplied.

In the conventional printer, due to unevenness of load distribution of the recording material itself which is carried, a take-up position of the recording material taken up by the paper tube of the take-up roll gradually shifts toward the width direction thereof, thereby causing a take-up state to be uneven in the width direction of the paper tube, that is, causing so-called roll set. Thus, there is a risk in that because the recording material is taken up in a take-up state where extreme roll set is caused, wrinkles occur on the recording material on which recording is performed by the recording heat.

It is therefore an object of the present invention to provide a carrying device, a recording device, and a carrying method which are capable of suppressing occurrence of wrinkles on a carried recording material and increasing quality of recording by a recording head.

### DISCLOSURE OF THE INVENTION

To achieve the above-mentioned object, according to the present invention, a carrying device includes: a supply portion for supplying a recording material from a supply roll obtained by winding the recording material; a platen, which is provided such that the platen is opposed to a recording head for performing recording on the recording material supplied from the supply portion, for supporting the recording material; and a take-up portion for taking up, around the take-up roll, the recording material on which the recording has been performed by the recording head, in which the recording material is carried from the supply portion to the take-up portion, the carrying device further including suction means for sucking the recording material supported on the platen. The platen is provided with a plurality of recessed portions which are formed in positions corresponding to an area where the recording is performed by the recording head, are surrounded by a projected wall, extend from an upstream side to a downstream side in a carrying direction of the recording material, and are aligned in a width direction of the recording material. Further, each of the recessed portions has a bottom surface provided with a plurality of suction holes for sucking the recording material by the suction means.

According to the carrying device of the present invention structured as described above, the recording material carried on the platen is supported by being sucked to the recessed portions through the suction means and suction holes. The recessed portions are surrounded by the projected wall and extend from the upstream side to the downstream side of the carrying direction of the recording material, so the recording material is favorably sucked on the bottom surfaces of the recessed portions. As a result, wrinkles occurred in the carrying direction are straightened.

Each of the recessed portions of the platen provided to the carrying device according to the present invention preferably has a side continuous with the upstream side to the downstream side, which is inclined with respect to the carrying direction. As a result, a portion of the recording material corresponding to the vicinity of each corner portion formed by the bottom surface in the recessed portion and a side surface of the projected wall, shifts toward the width direction of the recording material as the carried recording material moves. Thus, generation of unevenness in a recording state of the recording material by the recording head is favorably suppressed. In other words, each of the recessed portions of the platen has the side continuous with the upstream side to the downstream side, which is inclined with respect to the carrying direction, it is possible to avoid a problem in that a way of contacting between the platen and the recording material differs in the width direction of the recording material. That is, in the present invention, when, for example, as means for accelerating drying of ink ejected onto the recording material at the time of recording, there is adopted a structure in which the platen itself is heated. In this case, the regenerate unique portions in the width direction of the recording material, such as a portion where the recording material comes into contact with the projected portion of the platen, a portion where the recording material does not come into contact with the projected portion of the platen, or a portion where the recording material comes into contact with the bottom surface in the recessed portion of the platen. Thus, how the ink dries differs, and how the ink droplets spread on the recording material differs there between, thereby making it possible to prevent induction of blur, and quality of recording by the recording head is further increased.

Further, still another carrying device according to the present invention includes: a supply portion having a roll shaft for supporting a supply roll obtained by winding a recording material around a support tube, for supplying the recording material from the supply roll; and a take-up portion for taking up, around a take-up roll, the recording material on which recording has been performed by a recording head for performing the recording on the recording material supplied from the supply portion, in which the recording material is carried from the supply portion to the take-up portion. The roll shaft is provided with a large-diameter portion for supporting the support tube at a position thereof corresponding to a central portion in a width direction of the recording material perpendicular to a carrying direction thereof.

According to the carrying device of the present invention structured as described above, the support tube wound with the recording material is supported at a position thereof corresponding to the central portion in the width direction of the recording material by the large-diameter portion of the roll shaft, thereby suppressing the central portion in the width direction of the recording material wound around the support tube from being bent in a state where the support roll is supported by the roll shaft, and suppressing occurrence of wrinkles on the recording material.

Further, the roll shaft of the supply portion provided to the carrying device according to the present invention may be provided with a large-diameter portion such that the large-diameter portion is movable in an axial direction thereof. As a result, it becomes possible to easily comply with the recording materials of various types which differ in width perpendicular to the carrying direction of the recording material.

Further, yet another carrying device according to the present invention includes: a supply portion for supplying a recording material from a supply roll obtained by winding the recording material; and a take-up portion for taking up, around a take-up roll, the recording material on which recording has been performed by a recording head for performing the recording on the recording material supplied from the supply portion, in which the recording material is carried from the supply portion to the take-up portion. The carrying device further includes a supply-side tension roller, which is provided on a carriage path of the recording material between the recording head and the supply portion, for applying to the recording material a tensile force in a direction opposite to a carrying direction thereof.

According to the carrying device of the present invention structured as described above, on the carrying path of the recording material between the recording head and the supply portion, the tensile force in the direction opposite to the carrying direction is applied to the recording material by the supply-side tension roller at uniform distribution. Accordingly, the recording 3 material between the recording head and the supply portion is suppressed from slacking, so occurrence of wrinkles on the recording material is suppressed.

Further, yet another carrying device according to the present invention includes: a supply portion for supplying a recording material from a supply roll obtained by winding the recording material; and a take-up portion for taking up, around a take-up roll, the recording material on which recording has been performed by a recording head for performing the recording on the recording material supplied from the supply portion, in which the recording material is carried from the supply portion to the take-up portion. The carrying device further includes a separation roller, which extends between an inner peripheral surface of the recording material drawn out from the supply roll and an outer peripheral surface of the supply roll and is pressed to the recording material, for separating the inner peripheral surface of the recording material from an outer peripheral surface of the supply roll.

According to the carrying device of the present invention structured as described above, by the separation roller, the inner peripheral surface of the recording material drawn out from the supply roll is smoothly peeled from the outer peripheral surface of the supply roll to be separated. Thus, the recording material to be drawn out from the supply roll is smoothly drawn out from the supply roll, whereby preferably suppressing occurrence of wrinkles due to unevenness in tensile force caused as a result of a state where the outer peripheral surface of the supply roll and the inner peripheral surface of the recording material are adhered to each other unevenly in the width direction.

Further, yet another carrying device according to the present invention includes: a supply portion for supplying a recording material from a supply roll obtained by winding the recording material; and a take-up portion for taking up, around a take-up roll, the recording material on which recording has been performed by a recording head for performing the recording on the recording material supplied from the supply portion, in which the recording material is carried from the supply portion to the take-up portion. The carrying device further includes: a take-up-side tension roller, which is provided on a carriage path of the recording material between the recording head and the take-up roll, for applying to the recording material taken up by the take-up roll a tensile force in a direction opposite to a carrying direction thereof by its own weight; and a guide member for restricting a relative position of the take-up-side tension roller with respect to the take-up roll. The guide member has a contact surface brought into contact with the take-up-side tension roller, the contact surface being inclined with respect to a vertical direction.

According to the carrying device of the present invention structured as described above, when the take-up-side tension roller is moved so as to be close to the take-up roll, the guide member applies to the take-up-side tension roller a reaction force obliquely in a vertically downward direction. The reaction force acts in this manner, whereby the take-up-side tension roller performs a rocking movement about a center in the axial direction as a rotation fulcrum, which causes both end portions thereof to alternately be adjacent to/spaced apart from the take-up roll of the take-up portion. By performing the rocking movement, on the take-up-side tension roller, displacement of a take-up position in the width direction of the recording sheet, which is taken up by the take-up roll, is automatically corrected. Therefore, the roll set caused in the take-up roll is suppressed, and the recording sheet can be favorably taken up by the take-up roll. Thus, the occurrence of wrinkles on the carried recording material as well as the roll set caused in the take-up roll are suppressed.

It is preferable that the roll shaft of the supply portion provided to the carrying device according to the present invention be provided with engagement means engaged with an inner peripheral portion of a support tube of the supply roll obtained by winding the recording material around the support tube, and be engaged with the support tube, which is positioned with respect to an axial direction of the roll shaft with reference to an end surface of the recording material wound around the support tube, through the engagement means. The engagement means is engaged with the inner peripheral portion of the support tube positioned with reference to the end surface of the recording material as described above, thereby being capable of positioning and fixing the supply roll with high accuracy with respect to the axial direction of the roll shaft.

Further, yet another recording device for performing recording on a recording material by a recording head according to the present invention includes the carrying device according to the present invention described above.

Further, a method of carrying a recording material according to the present invention includes: pressing the recording material by a supply-side tension roller between a recording head performing recording on the recording material and a supply portion for supplying the recording material from a supply roll to the recording head; and applying to the recording material a tensile force in a direction opposite to a carrying direction of the recording material.

Further, a method of carrying a recording material according to the present invention includes: pressing the recording material by a take-up-side tension roller by own weight of the take-up-side tension roller between a recording head for performing recording on the recording material and a take-up portion for taking up, around a take-up roll, the recording material on which the recording has been performed by the recording head; and applying to the recording material taken up by the take-up roll a tensile force in a direction opposite to a carrying direction of the recording material.

### BRIEF DESCRIPTION OF THE DRAWINGS

FIG. 1 is a side view for illustrating a structure of an ink jet printer according to the present invention.

FIG. 2 is a perspective view showing a roll shaft of a supply portion of a carrying unit.

FIG. 3 is a side view showing a state where a supply roll is supported by the roll shaft.

FIG. 4 is a sectional view showing a chucking part.

FIG. 5 is a perspective view showing the chucking part.

FIG. 6 is a perspective view showing a platen.

FIG. 7 is a perspective view showing recessed portions of the platen.

FIG. 8 is a perspective view showing recessed portions of another platen.

FIG. 9 is a perspective view showing a take-up roll.

FIG. 10 is a perspective view showing a take-up-side tension roller.

### BEST MODE FOR CARRYING OUT THE INVENTION

Hereinafter, a specific embodiment of the present invention will be described with reference to the drawings.

In an ink jet printer according to this embodiment, as a recording material, for example, a recording material formed of paper, a synthetic resin, or the like is used, the recording material having a relatively large width, that is, for example, a width dimension perpendicular to a carrying direction of about 2 m to 2.5 m. For the sake of convenience, a description will be made while taking a recording sheet as an example.

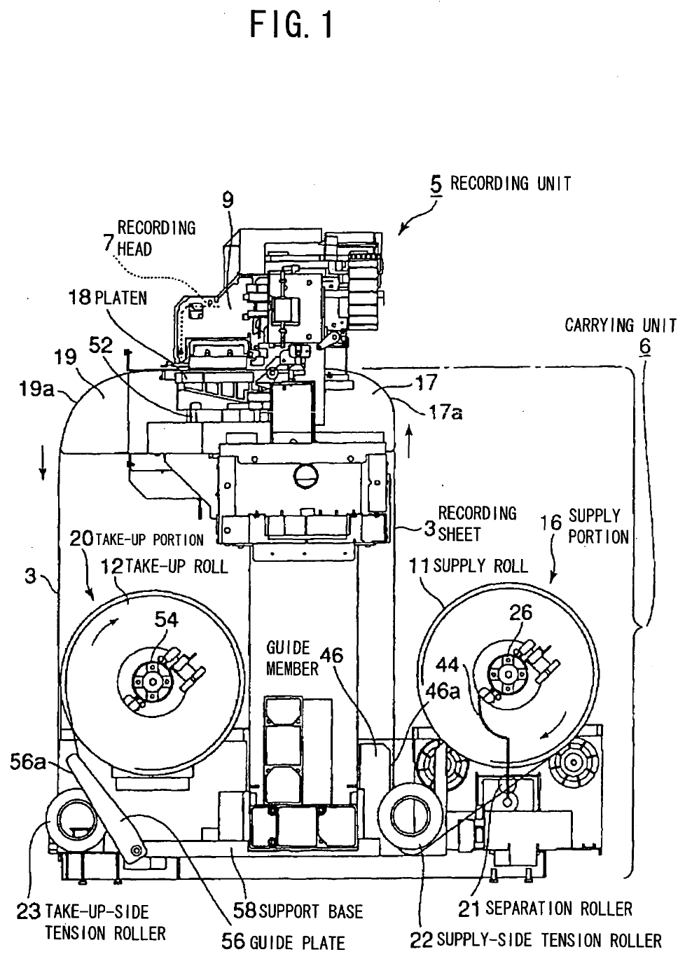

As shown in FIG. 1, the ink jet printer includes a recording unit 5 for performing recording on a recording sheet 3 and a carrying unit 6 for carrying the recording sheet 3 on which recording is performed by the recording unit 5.

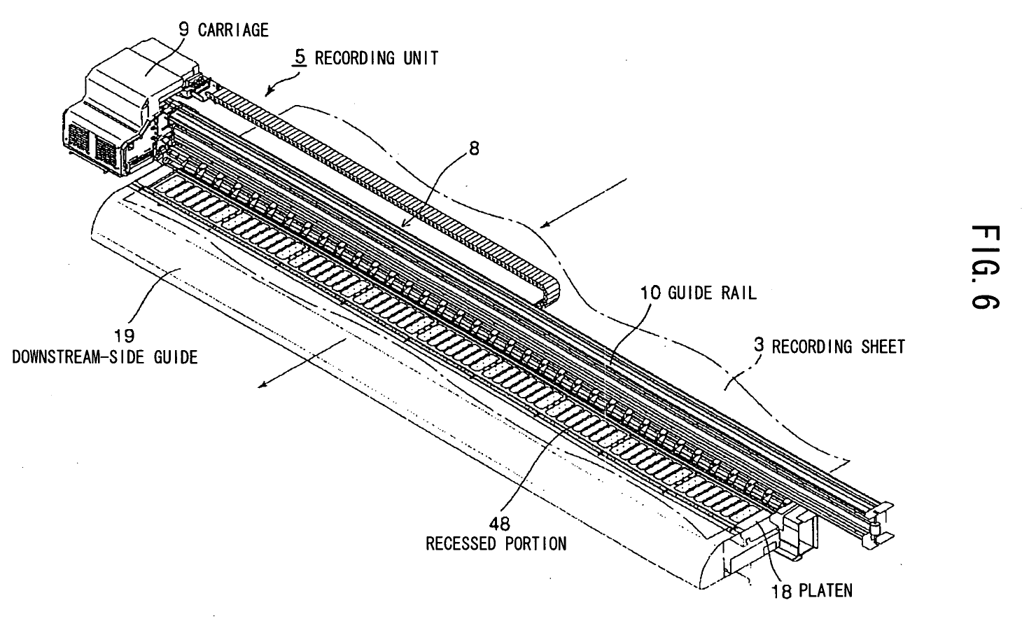

The recording unit 5 includes, as shown in FIGS. 1 and 6, includes a recording head 7 for ejecting ink droplets onto the recording sheet 3 and a head moving mechanism 8 for allowing the recording head 7 to scan in a width direction of the recording sheet 3 perpendicular to a carrying direction thereof. The head moving mechanism 8 includes a carriage 9 for holding the recording head 7, a guide rail 10 for guiding the carriage 9 such that the carriage 9 is movable in the width direction of the recording sheet 3, a drive motor (not shown) for driving the carriage 9 along the guide rail 10, and the like.

As shown in FIG. 1, the carrying unit 6 includes, in an order of passage of the recording sheet 3 in a carriage path thereof, a supply portion 16 for supporting a supply roll 11 for supplying the recording sheet 3, a front paper guide 17 for guiding the recording sheet 3 carried into the recording head 7 side, a platen 18 for supporting the recording sheet 3 on which recording is performed by the recording head 7, a rear paper guide 19 for guiding the recording sheet 3 carried out from the recording head 7 side, and a take-up portion 20 for supporting a take-up roll 12 for taking-up the recording sheet 3 on which the recording is performed by the recording head 7.

The carrying unit 6 includes a separation roller 21 for separating an inner peripheral surface of the recording sheet 3 from an outer peripheral surface of the supply roll 11 by pressing the recording sheet 3 drawn out from the supply roll 11, a supply-side tension roller 22 for applying, in the carriage path between the supply portion 16 and the recording head 7 of the recording unit 5, a tensile force by its own weight to the recording sheet 3 in a direction opposite to the carrying direction of the recording sheet 3, and a take-up-side tension roller 23 for applying, in the carriage path between the recording head 7 of the recording unit 5 and the take-up portion 20, a tensile force by its own weight to the recording sheet 3 in the direction opposite to the carrying direction of the recording sheet 3 to be taken up by the take-up roll 12.

The supply portion 16 includes a roll shaft 26 for supporting a support tube 4 (herein after, referred to as paper tube 4) of the supply roll 11 obtained by winding the recording sheet 3 around the paper tube 4, a support structure (not shown) for rotatably supporting the roll shaft 26, and a drive mechanism (not shown) for intermittently rotating the supply roll 11.

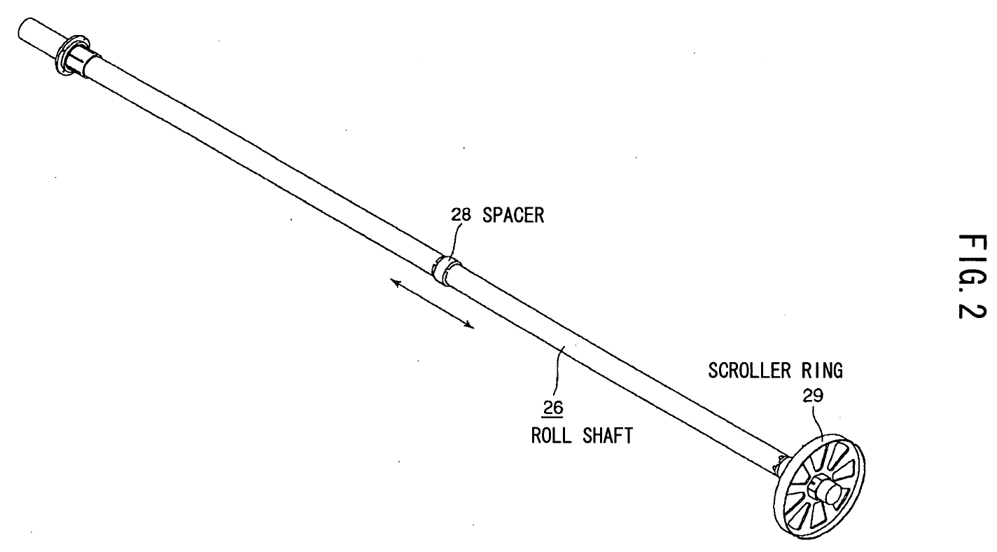

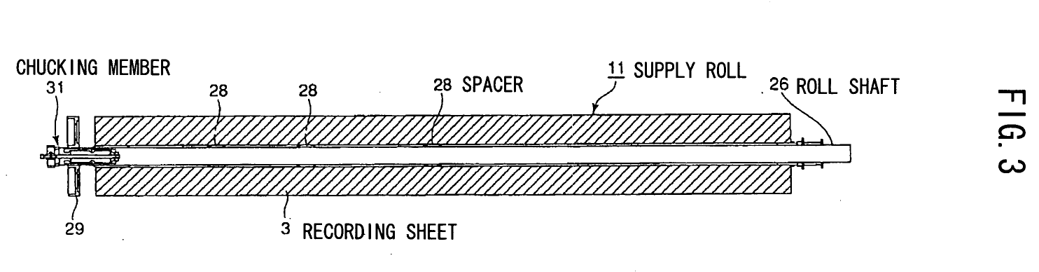

As shown in FIGS. 2 and 3, the roll shaft 26 is formed in a tubular shape, and is provided with, on an outer peripheral portion thereof, an annular spacer 28 constituting a large-diameter portion for supporting a center in a width direction of the paper tube 4 such that the spacer 28 is rotatable. The spacer 28 is moved to an arbitrary position along an axial direction of the roll shaft 26 according to a width of the recording sheet 3 of the supply roll 11, is fixed at both sides in the axial direction thereof by fixing screws or the like, and can correspond to width dimensions of the recording sheets 3 of various types.

One end portion of the roll shaft 26 is provided with a scroller ring 29 fixed thereto, which comes into contact with a drive ring (not shown) to which a rotary driving force is transmitted from the drive motor (not shown) through a timing belt (not shown) and receives torque. The one end portion of the roll shaft 26 is provided with a chucking member 31 fixed thereto, for positioning and fixing the paper tube 4 of the supply roll 11 with respect to the axial direction of the roll shaft 26.

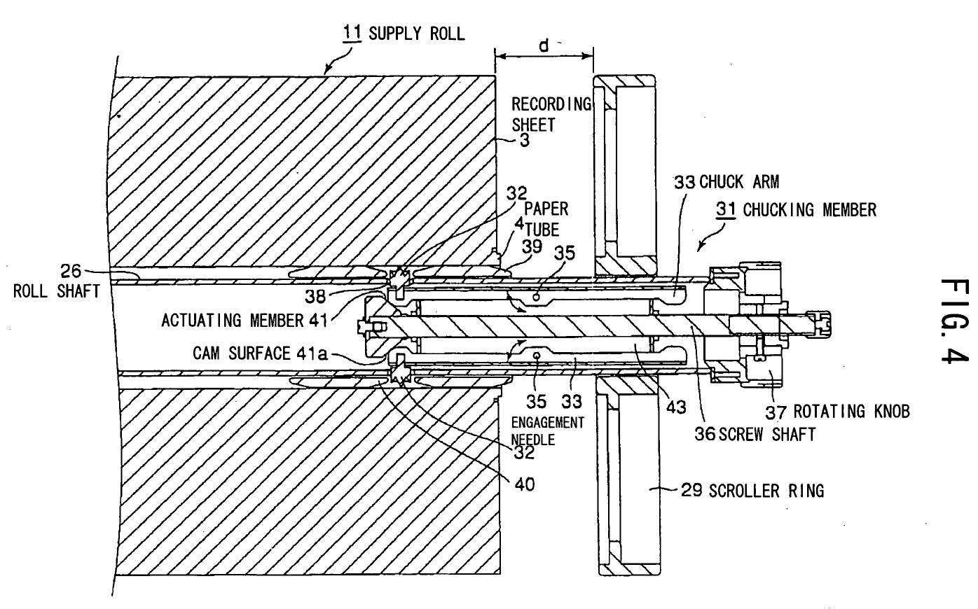

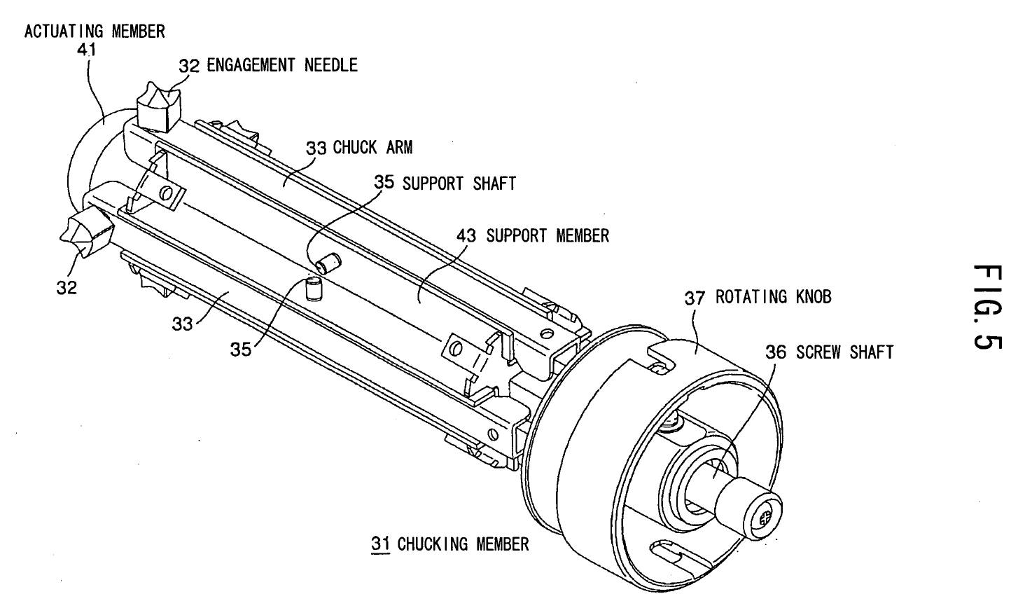

As shown in FIGS. 4 and 5, the chucking member 31 includes a plurality of engagement needles 32 to be engaged with the paper tube 4 of the supply roll 11, a plurality of chuck arms 33 each of which supports the engagement needle 32 at one end portion thereof and is pivotable about a support shaft 35 at a central portion, a screw shaft 36 for rotating the chuck arms 33, and a rotating knob 37 for rotating and operating the screw shaft 36.

The roll shaft 26 has a plurality of slits 38 formed therein allowing advancement and retraction of the engagement needles 32, and has, in a position thereof corresponding to the slits 38, a tubular protective sleeve 39 for preventing a user from touching the engagement needles 32. The protective sleeve 39 has, in a position thereof corresponding to the slits 38 of the roll shaft 26, slits 40 formed therein allowing advancement and retraction of the engagement needles 32.

The screw shaft 36 is provided with, on one end portion thereof facing an inside of the roll shaft 26, an actuating member 41 fixed thereto for actuating the chuck arms 33, and on the other end portion thereof exposed to an outside, the rotating knob 37. The actuating member 41 is formed with a cam surface 41a brought into contact with the one end portion of each of the chuck arms 33, and is moved in the axial direction of the screw shaft 36 when the screw shaft 36 rotates. The chuck arms 33 are rotatably supported by a support member 43 through the support shafts 35. The screw shaft 36 is provided to the support member 43 so as to be rotatable.

In the chucking member 31 structured as described above, the rotating knob 37 is rotated to be operated, thereby rotating the screw shaft 36, and when the screw shaft 36 rotates, the actuating member 41 is moved in the axial direction. According to a movement amount of the actuating member 41 in the axial direction, the actuating member 41 allows the chuck arms 33 to be rotated about the support shafts 35 by the cam surface 41a, thereby allowing the engagement needles 32 to protrude from the slits 38 and 40 so that the engagement needles 32 are engaged with the inner peripheral surface of the paper tube 4.

Positioning of the supply roll 11 is performed in such a manner that a gage or the like (not shown) is used, thereby positioning an end surface of the recording sheet 3 wound around the paper tube 4 with respect to an end surface of the scroller ring 29. The supply roll 11, which is positioned with respect to the axial direction of the roll shaft 26 in the above-mentioned manner, is fixed in position by allowing the engagement needles 32 to engage with the inner peripheral surface of the paper tube 4 by the above-mentioned chucking member 31.

Conventionally, when the paper tube of the supply roll is positioned with respect to the roll shaft, the end surface of the scroller ring is caused to abut on an end surface of the paper tube, thereby performing fixation thereof. That is, in a conventional positioning method, the positioning is performed with respect to the roll shaft by using the end surface of the paper tube of the supply roll as a reference. Therefore, there is a problem in that due to variations in take-up position of the recording sheet with respect to the paper tube, there are caused variations in positions of the recording sheet with respect to the roll shaft.

However, in this embodiment, as shown in FIG. 4, a gap d between the end surface of the scroller ring 29 and the end surface of the recording sheet 3 wound around the paper tube 4 is positioned by the gage or the like with high accuracy. The paper tube 4, which is positioned with respect to the axial direction of the roll shaft 26 with high accuracy by using the end surface of the recording sheet 3 as a reference, is fixed in position by using the chucking member 31, thereby making it possible to position the recording sheet 3 with respect to the axial direction of the roll shaft 26 with high accuracy regardless of the variations in take-up position of the recording sheet 3 with respect to the paper tube 4.

As shown in FIG. 1, the separation roller 21 is arranged in a position adjacent to the supply roll 11 of the supply portion 16 such that an axial direction is parallel to that of the roll shaft 26 of the supply portion 16. The separation roller 21 extends between the inner peripheral surface of the recording sheet 3 drawn out from the supply roll 11 and an outer peripheral surface of the supply roll 11 and is pressed on the entire width direction of the recording sheet 3. The separation roller 21 is supported at both ends thereof by support arms 44. The support arms 44 are rotatably supported on both ends of the roll shaft 26.

In a case where the inner peripheral surface of the recording sheet 3 to be drawn out from the supply roll 11 adheres to the outer peripheral surface of the supply roll 11 and cannot easily be peeled therefrom, as the separation roller 21 is moved upwards together with the inner peripheral surface of the recording sheet 3 which has been drawn out by using the roll shaft 26 as a rotation fulcrum, and the separation roller 21 moves down by its own weight, the inner peripheral surface of the recording sheet 3 is smoothly peeled to be separated from the outer peripheral surface of the supply roll 11. As a result, the recording sheet 3 is smoothly drawn out from the supply roll 11 without causing the tensile force thereof to be uneven in the width direction, and occurrence of wrinkles is favorably suppressed.

The supply-side tension roller 22 is arranged in a position adjacent to the separation roller 21 such that an axial direction thereof is parallel to that of the roll shaft 26 of the supply portion 16. The supply-side tension roller 22 presses the recording sheet 3 drawn out from the supply roll 11 on the entire width direction of the recording sheet 3 vertically downwards by its own weight. Further, a moving range of both ends in the axial direction of the supply-side tension roller 22 is restricted by guide members 46. Each of the guide members 46 is formed with a guide groove 46a for restricting the supply-side tension roller 22 to move only in a vertical direction.

The supply roll 11 supported by the roll shaft 26 of the supply portion 16 has a structure in which according to a winding direction of the recording sheet 3, that is, according to whether a recording surface side of the recording sheet 3 wound around the paper tube 4 faces the paper tube 4, a position where the recording sheet 3 is drawn out from the supply roll 11 supported by the roll shaft 26 differs. Thus, in order to apply an appropriate tensile force to the recording sheet 3 by the supply-side tension roller 22, the guide member 46 is provided so as to be movable with respect to the roll shaft 26. According to the position of the guide member 46, a relative position of the supply-side tension roller 22 with respect to the roll shaft 26 is favorably adjusted.

The recording sheet 3 which has passed by the supply-side tension roller 22, is carried vertically upwards, and is applied with a tensile force in a vertically downward direction by the supply-side tension roller 22. The recording sheet 3 is applied with the tensile force, which is uniformly distributed in the width direction, in a direction opposite to the carrying direction thereof by the supply-side tension roller 22 in the above-mentioned manner. Therefore, the recording sheet 3 between the front paper guide 17 and the supply portion 16 is suppressed from slacking, and is favorably pressed to a slide contact surface 17a described later of the front paper guide 17. Thus, occurrence of wrinkles is suppressed and the recording sheet 3 is effectively heated in advance by a heater described later. Further, as with the separation roller 21 as described above, the supply-side tension roller 22 also applies a tensile force in the carrying direction to the recording sheet 3 drawn out from the supply roll 11. Therefore, the supply-side tension roller 22 cooperates with the separation roller 21 to favorably separate the recording sheet 3 from the supply roll 11, thereby smoothly drawing out the recording sheet 3.

The front paper guide 17 has the slide contact surface 17a having a circular arc shape, for allowing the recording sheet 3 conveyed from vertically below to be conveyed in a horizontal direction. By heating of the heater (not shown) joined to a rear surface of the front paper guide 17, the recording sheet 3 on which the recording is to be performed by the recording head 7 is heated in advance.

As shown in FIGS. 1 and 6, the platen 18 is arranged in a position opposed to an area where the recording head 7 moves, and is formed of a material having relatively high heat conductivity, such as aluminum into a plate-like shape. The platen 18 has a dimension in parallel to the carrying direction of the recording sheet 3, which is substantially the same as a dimension of the recording area where recording is performed by a nozzle (not shown) of the recording head 7.

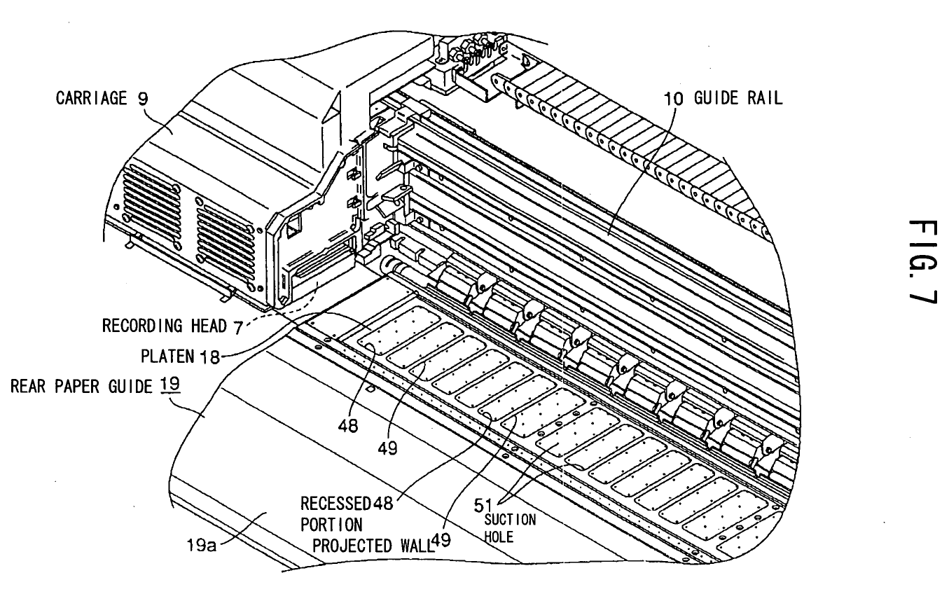

As shown in FIG. 7, the platen 18 has, in a surface thereof opposed to the recording head 7, a plurality of recessed portions 48, which are aligned in the width direction of the recording sheet 3 so as to correspond to the area in which recording is performed by the recording head 7. Each of the recessed portions 48 is formed into a substantially rectangular shape. A long side thereof extends from an upstream side to a downstream side of the carrying direction of the recording sheet 3. An entire periphery of each of the recessed portion 48 is surrounded by a frame-like projected wall 49. Each of the recessed portions 48 is formed to have a long side connecting the upstream side and the downstream side, which is parallel to the carrying direction of the recording sheet 3.

Each of the recessed portions 48 is formed to have a depth of about 0.3 to 0.4 mm and a width parallel to the width direction of the recording sheet 3 of 8 mm or more. A gap between the recording sheet 3 supported on the platen 18 and the recording head 7 is set to be about 1.6 to 2.9 mm.

A plurality of suction holes 51 are formed in a bottom surface of each of the recessed portions 48 at a predetermined pitch in parallel to the carrying direction of the recording sheet 3. In each of the recessed portions 48 in positions corresponding to the end portions in the width direction of the recording sheet 3 to be carried, an area of the bottom surface is relatively large and the number of suction holes 51 is increased, thereby making it possible to favorably suck and hold the end portions of the recording sheet 3 in the width direction thereof. As shown in FIG. 1, a plurality of suction fans 52 are arranged below the platen 18, and the suction holes 51 of the platen 18 is allowed to communicate with air flow paths owing to the suction fans 52, respectively.

In a position adjacent to a lower portion of the platen 18, there is arranged a heater (not shown). The platen 18 is heated by the heater, whereby ink, which is ejected from the recording head 7 and reaches the recording sheet 3, is dried.

According to the platen 18 structured as described above, an entire periphery of each of the recessed portions 48 extending from the upstream side to the downstream side is surrounded by the projected wall 49. Thus, a sufficient suction force is generated through the suction holes 51 in the recessed portions 48, thereby allowing the recording sheet 3 to be favorably sucked and supported in a flat state along the bottom surfaces of the recessed portions 48 from the upstream side to the downstream side. Accordingly, on the recording sheet 3 supported on the platen 18, wrinkles tend to occur in the carrying direction are straightened, and the gap between the recording head 7 and the recording surface of the recording sheet 3 is uniformized, thereby increasing the quality of recording by the recording head 7.

In the ink jet printer according to this embodiment, the recessed portions 48 are provided in the platen 18, thereby making it possible to achieve downsizing as compared to the conventional structure in which the recessed/projected guide portion is provided on the downstream side of the platen.

The above-mentioned platen 18 has a structure in which the long side thereof, continuous with the upstream side and the downstream side of the recessed portions 48, is parallel with the carrying direction of the recording sheet 3. However, it is desirable that the long side be inclined at a predetermined inclination angle with respect to the carrying direction. An other platens having this structure will be described.

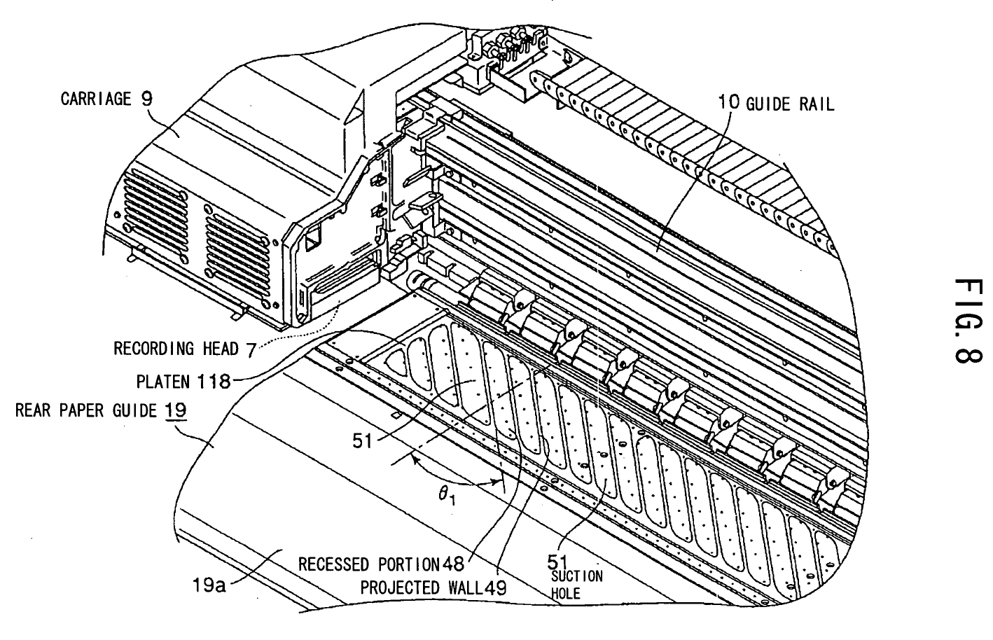

As shown in FIG. 8, another platen 118 is provided with a plurality of recessed portions 148 aligned in the width direction of the recording sheet 3 on a surface opposed to the recording head 7. Each of the recessed portions 148 is formed into a substantially quadrilateral, has a long side extending from the upstream side to the downstream side in the carrying direction of the recording sheet 3, and is surrounded by a frame-like projected wall 149 over an entire periphery thereof. A depth of each of the recessed portions 148 and a width (short side) thereof in parallel with the width direction of the recording sheet 3 are the same as those of the recessed portion 48 described above.

Each of the recessed portions 148 has a long side continuous with the upstream side and the downstream side in the carrying direction inclined at an inclination angle θ₁ with respect to the carrying direction. The inclination angle θ₁ of each of the recessed portions 148 is smaller than 90 degrees, for example, about 40 degrees. Note that, although not shown, while being inclined at the inclination angle θ₁, the recessed portions may be arranged symmetrically with respect to a center line of the width direction of the platen, for example.

In the platen 118 structured as described above, in the vicinity of each corner portion, which is formed by a bottom surface of the recessed portion 148 and a side surface of the projected wall 149, it is difficult for the recording sheet 3 to be brought into contact with the platen 118. Therefore, there is a tendency in that a part of the recording sheet 3 corresponding to the above-mentioned portion is less prone to be dried by the heater. However, according to the platen 118, the long side of the recessed portion 148 is inclined at the inclination angle θ₁ with respect to the carrying direction, whereby, when the recording sheet 3 to be carried is moved, the vicinity of each of the corner portions, which is formed by the bottom surface of the recessed portion 148 and the side surface of the projected wall 149, continuously shifts with respect to the width direction of the recording sheet 3. Therefore, according to the platen 118, the position on the recording sheet 3 where the drying is difficult is shifted toward the width direction, thereby favorably suppressing generation of unevenness in a drying state of the recording sheet 3 and preventing occurrence of linear trace or the like on the recording sheet 3.

The rear paper guide 19 has a circular arc slide surface 19a for allowing the recording sheet 3, which is carried in a horizontal direction from the platen 18 side, to be carried vertically downwards. The slide surface 19a is heated by a heater (not shown) arranged adjacent to the rear paper guide 19, to thereby heat the recording sheet 3 on which recording has been performed by the recording head 7.

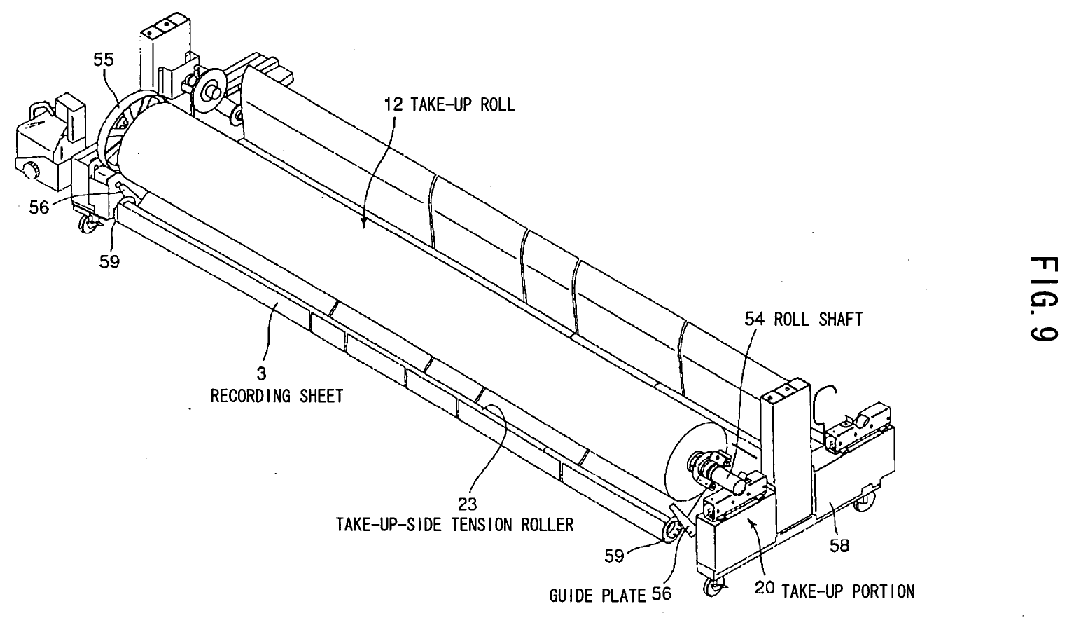

As shown in FIGS. 1 and 9, the take-up portion 20 includes a cylindrical roll shaft 54 for supporting the paper tube 4 of the take-up roll 12 wound with the recording sheet 3, a support frame (not shown) for supporting the roll shaft 54 in a rotatable manner, and a drive mechanism (not shown) for intermittently rotating the take-up roll 12. An end portion of the roll shaft 54 is brought into contact with a drive ring (not shown) to which a rotary driving force is transmitted through a timing belt (not shown) by a drive motor (not shown), and is provided with a scroller ring 55, fixed to the end portion, for receiving torque.

As shown in FIG. 9, the take-up-side tension roller 23 is arranged in a position adjacent to the take-up roll 12 of the take-up portion 20 so as to have an axial direction thereof in parallel with the roll shaft 54 of the take-up portion 20. The take-up-side tension roller 23 presses the recording sheet 3 to be carried vertically downwards by its own weight on the entire width direction thereof, thereby applying a tensile force opposite to the carrying direction to the recording sheet 3 to be taken up by the take-up roll 12.

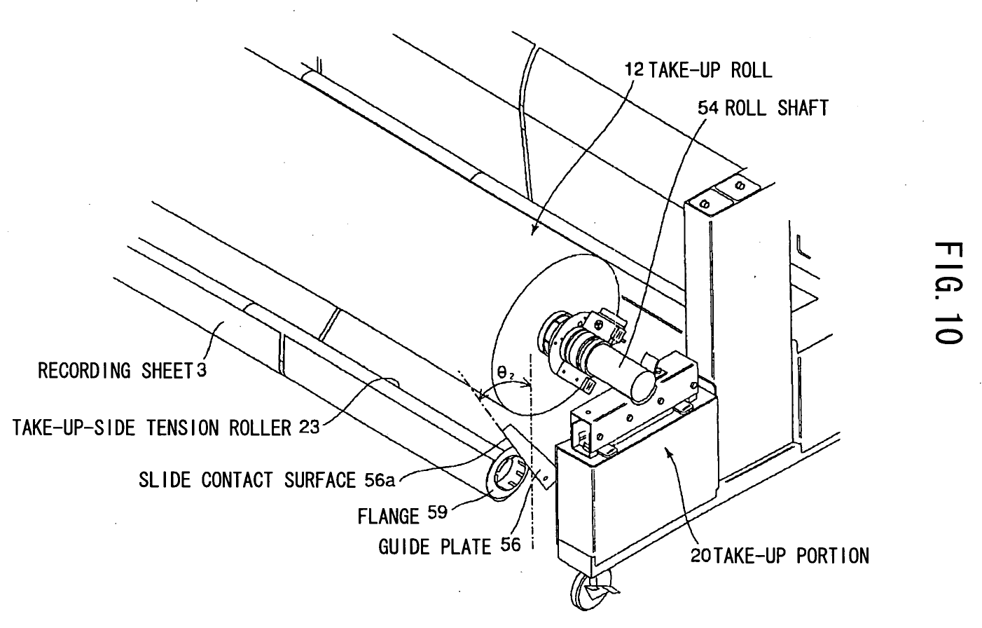

As shown in FIGS. 9 and 10, both ends in the axial direction of the take-up-side tension roller 23 are brought into contact with guide plates 56, respectively. A relative position of the take-up-side tension roller 23 with respect to the take-up roll 12 is restricted, thereby restricting the movement of the take-up-side tension roller 23. Each of the guide plates 56 is fixed at one end thereof to a support base 58 supporting components such as the supply portion 16 and the take-up portion 20. As shown in FIG. 10, the guide plate 56 is provided with a slide contact surface 56a which is brought into slide contact with an outer peripheral surface of each end portion of the take-up-side tension roller 23, and is fixed in a state where the slide contact surface 56a has a predetermined inclination angle θ₂ with respect to the vertical direction.

When the end portion of the take-up-side tension roller 23 is moved so as to be adjacent to the take-up roll 12 side, with the inclination angle θ₂ of the slide contact surface 56a being set to, for example, about 30 degrees, the guide plate 56 applies through the slide contact surface 56a a reaction force obliquely in a vertically downward direction to the end portion of the take-up-side tension roller 23, and functions to restrict movement of the end portion of the take-up-side tension roller 23.

Each of both sides of the take-up-side tension roller 23 is provided with a flange 59 for guiding a position of the recording sheet 3 in the width direction thereof. The guide plate 56 is brought into slide contact with the outer peripheral surface of each of the end portions of the take-up-side tension roller 23 and the side surface of the flange 59. The guide plate 56 is provided so as to be movable with respect to the roll shaft 54 of the take-up portion 20 in order to apply an appropriate tensile force to the recording sheet 3 by the take-up-side tension roller 23. According to a position of the guide plate 56, the relative position of the take-up-side tension roller 23 with respect to the roll shaft 54 is favorably adjusted.

According to the take-up-side tension roller 23 structured as described above, when a so-called roll set is caused, in which the recording sheet 3 is taken up by the take-up roll 12 in a biased manner in the width direction thereof, as the recording sheet taken up by the paper tube 4 in the biased manner is displaced, the take-up-side tension roller 23 is moved such that one end portion thereof becomes adjacent to the take-up roll 12. The movement of the one end portion which is moved is restricted by the slide contact surface 56a of the guide plate 56, thereby moving the other end portion of the take-up-side tension roller 23 to be adjacent to the take-up roll 12, and smoothly correcting the take-up position in the width direction of the recording sheet 3 taken up by the paper tube 4.

That is, according to a state of the roll set caused in the recording sheet 3 taken up by the paper tube 4, the take-up-side tension roller 23 performs a rocking movement about a central portion in the axial direction as a rotation fulcrum, which causes both end portions thereof to alternately be adjacent to/spaced apart from the roll shaft 54 of the take-up portion 20. By performing the rocking movement, on the take-up-side tension roller 23, displacement of a take-up position in the width direction of the recording sheet 3, which is taken up by the take-up roll 12, is automatically corrected. Therefore, the roll set caused in the take-up roll 12 is suppressed, and the recording sheet 3 can be favorably taken up by the sheet tube 4.

In the ink jet printer structured as described above, the recording sheet 3 drawn out from the supply roll 11 of the supply portion 16 is favorably separated from the supply roll 11 by the separation roller 21 to be smoothly drawn out. The recording sheet 3 drawn out from the supply roll 11 is applied with a tensile force by the supply side tension roller 22 and is carried to the recording head 7 through the front paper guide 17.

Next, the recording sheet 3 carried on the platen 18 is favorably sucked and supported on the bottom surfaces of the plurality of recessed portions 48, and ink droplets are ejected from the recording head 7, so the recording of an image or the like is performed. Subsequently, the recording sheet 3, on which the recording has been performed by the recording head 7, is carried through the rear paper guide 19, and is applied with a tensile force by the take-up-side tension roller 23, thereby suppressing the roll set from occurring in the take-up roll 12. As a result, the recording sheet 3 is favorably taken up by the take-up roll 12.

As described above, according to the ink jet printer, there is provided the platen 18 with the recessed portions 48, thereby allowing the recording sheet 3 to be favorably sucked and supported on the bottom surfaces in the recessed portions 48. Therefore, wrinkles occurred on the recording sheet 3 in the carrying direction thereof is straightened and the quality of recording by the recording head 7 is increased.

Further, according to the ink jet printer, the paper tube 4 of the supply roll 11 is supported by the spacer 28, which is provided to the roll shaft 26, at a position of the paper tube 4 corresponding to the central portion in the width direction of the recording sheet 3, whereby in a state where the supply roll 11 is supported by the roll shaft 26, the recording sheet 3 is suppressed from being bent in the central portion in the width direction thereof, and wrinkles on the recording sheet 3 can be suppressed from occurring thereon.

According to the ink jet printer, there is provided the supply-side tension roller 22 for applying a tensile force in a direction opposite to the carrying direction of the recording sheet 3, thereby suppressing the recording sheet 3 between the recording head 7 and the supply portion 16 from slacking, and occurrence of wrinkles on the recording sheet 3 can be suppressed.

According to the ink jet printer, there is provided the separation roller 21 for separating the inner peripheral surface of the recording sheet 3 from the outer peripheral surface of the supply roll 11, thereby allowing a tensile force which is uniform in the width direction of the recording sheet 3 to act thereon, and the recording sheet 3 is smoothly drawn out from the supply roll 11. Thus, wrinkles are suppressed from occurring on the recording sheet 3 which is drawn out.

Further, according to the ink jet printer, there are provided the take-up-side tension roller 23 for applying, by its own weight, a tensile force in the direction opposite to the carrying direction of the recording sheet 3 taken up by the take-up roll 12, and the guide plates 56 for restricting the relative position of the take-up-side tension roller 23 with respect to the take-up roll 12, whereby the take-up-side tension roller 23 performs the rocking movement about the center in the axial direction thereof as a rotation fulcrum. Therefore, occurrence of the roll set in the take-up roll 12 is suppressed, so the recording sheet 3 can be favorably taken up by the take-up roll 12. Thus, occurrence of wrinkles on the recording sheet 3 which is carried as well as the roll set caused in the take-up roll 12 can be suppressed.

### INDUSTRIAL APPLICABILITY

As described above, according to the present invention, occurrence of wrinkles on a carried recording material is suppressed, thereby making it possible to increase quality of recording by a recording head.

1. A carrying device comprising:
a supply portion for supplying a recording material from a supply roll obtained by winding the recording material;
a platen, which is provided such that the platen is opposed to a recording head for performing recording on the recording material supplied from the supply portion, for supporting the recording material; and
a take-up portion for taking up, around the take-up roll, the recording material on which the recording has been performed by the recording head, in which the recording material is carried from the supply portion to the take-up portion, the carrying device further comprising suction means for sucking the recording material supported on the platen, wherein:
the platen is provided with a plurality of recessed portions which are formed in positions corresponding to an area where the recording is performed by the recording head, are surrounded by a projected wall, extend from an upstream side to a downstream side in a carrying direction of the recording material, and are aligned in a width direction of the recording material; and
each of the recessed portions has a bottom surface provided with a plurality of suction holes for sucking the recording material by the suction means.

2. A carrying device according to claim 1, wherein each of the recessed portions has a side continuous with the upstream side to the downstream side, the side being inclined with respect to the carrying direction.

3. A carrying device comprising:
a supply portion having a roll shaft for supporting a supply roll obtained by winding a recording material around a support tube, for supplying the recording material from the supply roll; and
a take-up portion for taking up, around a take-up roll, the recording material on which recording has been performed by a recording head for performing the recording on the recording material supplied from the supply portion, in which the recording material is carried from the supply portion to the take-up portion,
wherein the roll shaft is provided with a large-diameter portion for supporting the support tube at a position thereof corresponding to a central portion in a width direction of the recording material perpendicular to a carrying direction thereof.

4. A carrying device according to claim 3, wherein the roll shaft is provided with the large-diameter portion such that the roll shaft is movable in an axial direction thereof.

5. A carrying device comprising:
a supply portion for supplying a recording material from a supply roll obtained by winding the recording material; and
a take-up portion for taking up, around a take-up roll, the recording material on which recording has been performed by a recording head for performing the recording on the recording material supplied from the supply portion, in which the recording material is carried from the supply portion to the take-up portion, the carrying device further comprising a supply-side tension roller, which is provided on a carriage path of the recording material between the recording head and the supply portion, for applying to the recording material a tensile force in a direction opposite to a carrying direction thereof.

6. A carrying device according to claim 5, wherein the supply-side tension roller applies the tensile force by its own weight.

7. A carrying device comprising:
a supply portion for supplying a recording material from a supply roll obtained by winding the recording material; and
a take-up portion for taking up, around a take-up roll, the recording material on which recording has been performed by a recording head for performing the recording on the recording material supplied from the supply portion, in which the recording material is carried from the supply portion to the take-up portion, the carrying device further comprising a separation roller, which extends between an inner peripheral surface of the recording material drawn out from the supply roll and an outer peripheral surface of the supply roll and is pressed to the recording material, for separating the inner peripheral surface of the recording material from an outer peripheral surface of the supply roll.

8. A carrying device according to claim 7, wherein the separation roller is provided such that the separation roller is movable in parallel to the roll shaft and presses the recording material by its own weight.

9. A carrying device comprising:
a supply portion for supplying a recording material from a supply roll obtained by winding the recording material; and
a take-up portion for taking up, around a take-up roll, the recording material on which recording has been performed by a recording head for performing the recording on the recording material supplied from the supply portion, in which the recording material is carried from the supply portion to the take-up portion, the carrying device further comprising:
a take-up-side tension roller, which is provided on a carriage path of the recording material between the recording head and the take-up roll, for applying to the recording material taken up by the take-up roll a tensile force in a direction opposite to a carrying direction thereof by its own weight; and
a guide member for restricting a relative position of the take-up-side tension roller with respect to the take-up roll,
wherein the guide member has a contact surface brought into contact with the take-up-side tension roller, the contact surface being inclined with respect to a vertical direction.

10.-11. (canceled)

12. A method of carrying a recording material, comprising: pressing the recording material by a supply-side tension roller between a recording head performing recording on the recording material and a supply portion for supplying the recording material from a supply roll to the recording head; and
applying to the recording material a tensile force in a direction opposite to a carrying direction of the recording material.

13. A method of carrying a recording material, comprising:
pressing the recording material by a take-up-side tension roller by own weight of the take-up-side tension roller between a recording head for performing recording on the recording material and a take-up portion for taking up, around a take-up roll, the recording material on which the recording has been performed by the recording head; and
applying to the recording material taken up by the take-up roll a tensile force in a direction opposite to a carrying direction of the recording material.
